(19) United States
(12) Patent Application Publication
(10) Pub. No.: US 2013/0135350 A1
(43) Pub. Date: May 30, 2013

(54) SLANT AND OVERLAYING GRAPHICAL KEYBOARD

(71) Applicants: Lucinio Santos-Gomez, Durham, NC (US); Stephanie L. Trunzo, Raleigh, NC (US)

(72) Inventors: Lucinio Santos-Gomez, Durham, NC (US); Stephanie L. Trunzo, Raleigh, NC (US)

(73) Assignee: International Business Machines Corporation, Armonk, NY (US)

(21) Appl. No.: 13/305,231

(22) Filed: Nov. 28, 2011

(51) Int. Cl. G09G 5/00

(52) U.S. Cl. 345/649

(57) ABSTRACT

A slant keyboard module detects initiation of an application that accepts textual input in a mobile device. The slant keyboard module receives angle of orientation data from one or more orientation instruments in the mobile device. The slant keyboard module determines that the angle of orientation data indicates a slant angle of orientation. The slant keyboard module displays a graphical keyboard with a short-term text field at a slant angle of display corresponding to the slant angle of orientation. The slant keyboard module also displays a short-term text field at the slant angle of display. The short-term text field displays a limited number of most recent input characters to the graphical keyboard.

### BACKGROUND

Embodiments of the inventive subject matter generally relate to the field of mobile devices, and, more particularly, to diagonally displaying a graphical keyboard.

Devices with touchscreens typically include on-screen keyboards (software simulated keyboards) that allow users to enter text by tapping on an on-screen keyboard. Conventionally, the on-screen keyboard is displayed in a horizontal or a vertical orientation in accordance with the orientation at which a mobile device is held. The layout of the on-screen keyboard changes in accordance with the orientation. The vertical layout of an on-screen keyboard compresses the keys into a narrow area on a touchscreen. The horizontal layout of an on-screen keyboard distributes the keys across a wider area, thus covering a larger portion of the touchscreen.

### SUMMARY

Embodiments of the inventive subject matter include a method to display a graphical keyboard at a slant angle of display. The method detects initiation of an application that accepts textual input in a mobile device. The method receives angle of orientation data from one or more orientation instruments in the mobile device. The method determines that the angle of orientation data indicates a slant angle of orientation. The method displays the graphical keyboard on a screen of the mobile device at the slant angle of display. The slant angle of display corresponds to the slant angle of orientation. The method also displays a short-term text field at the slant angle of display. The short-term text field displays a limited number of most recent input characters to the graphical keyboard.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a conceptual diagram of an example graphical keyboard at a slant angle on the touchscreen of a mobile device.

FIG. 2 depicts a conceptual diagram of example angles of display for a graphical keyboard.

FIG. 3 illustrates a flow diagram of example operations to display a graphical keyboard and accept textual input.

FIG. 4 illustrates a flow diagram of example operations to determine an angle of display for a graphical keyboard and display the graphical keyboard.

FIG. 5 depicts an example mobile device 500.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to a slant keyboard program as a component of the mobile device operating system, embodiments do not necessarily require the slant keyboard program to be a part of the mobile device operating system. In other instances, well-known instruction instances, protocols, structures and techniques have not been shown in detail in order not to obfuscate the description.

A slant keyboard program displays an on-screen keyboard (hereinafter “graphical keyboard”) diagonally in addition to horizontally or vertically. The term ^{“}program” is used herein to refer to either a set of computer program instructions or to an executing instance of the set of computer program instructions. A portable device (e.g., tablet, mobile phone, etc.) can display a diagonal graphical keyboard at an angle ergonomically suited for simultaneous use of both hands. With a graphical keyboard in slant orientation, one hand holds the portable device while the other hand interacts with the graphical keyboard more naturally and/or ergonomically than when the keyboard is displayed in a linear alignment (i.e., horizontally or vertically) while being held with one hand. An operating system component can perform the operations for displaying a graphical keyboard at a slant angle. The operating system component determines an appropriate layout for the diagonal graphical keyboard based on one of multiple slant angles at which the graphical keyboard is displayed.

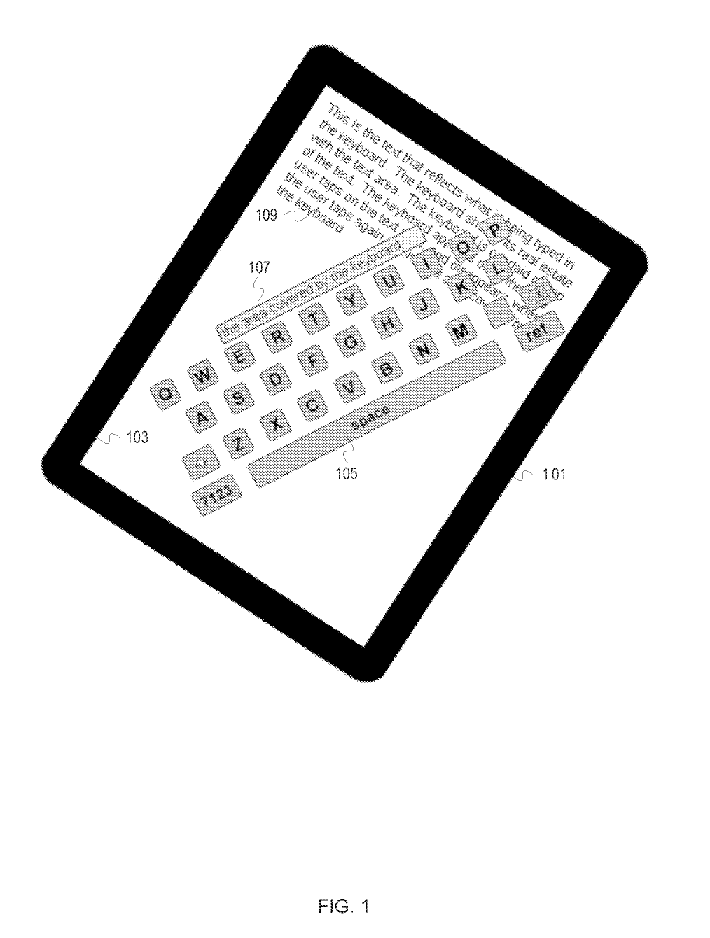

FIG. 1 depicts a conceptual diagram of an example graphical keyboard at a slant angle on the touchscreen of a mobile device. FIG. 1 depicts a mobile device 101 with a touchscreen 103. The touchscreen 103 exhibits a graphical keyboard 105 with a short-term text field 107. The touchscreen 103 also exhibits a text area 109 beneath the graphical keyboard 105. Angles of orientation for the mobile device 101 refer to angles measured with reference to a horizontal position of the mobile device 101. The graphical keyboard 105 is displayed at a slant angle in an opposite direction to an angle of orientation for the mobile device 101. For example, when the mobile device 101 is held at an angle of 30 degrees from horizontal in a clockwise direction, the graphical keyboard 105 is displayed at an angle of 30 degrees from horizontal in an anti-clockwise direction.

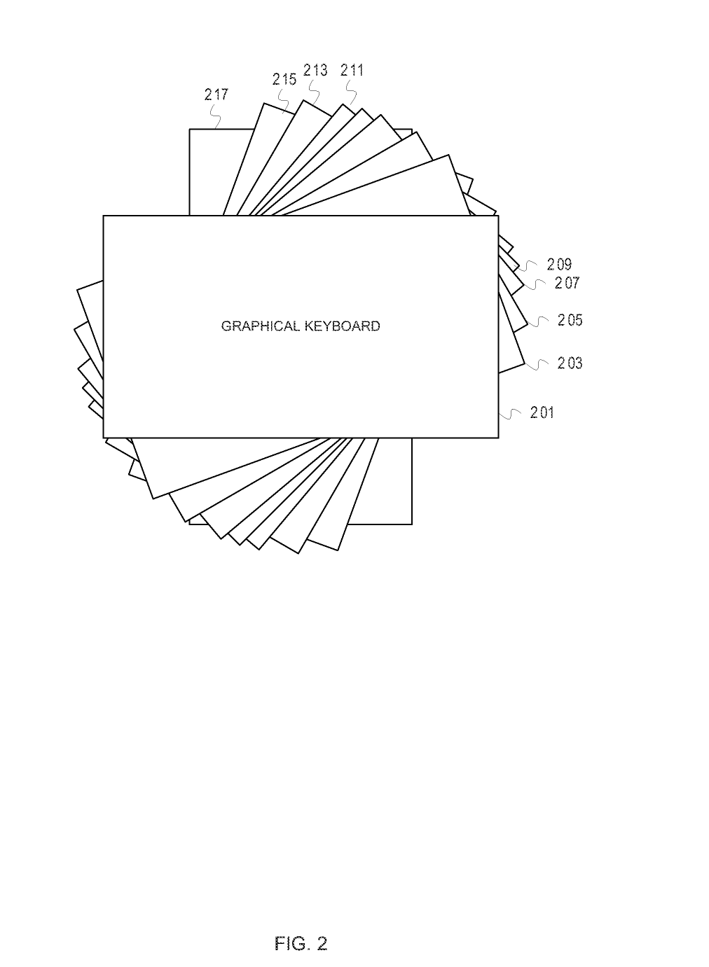

FIG. 2 depicts a conceptual diagram of example angles of display for a graphical keyboard. FIG. 2 depicts multiple positions: a horizontal position 201, a vertical position 217 and seven slant angle positions. The seven slant angles are measured from the horizontal position 201. The slant angle positions include: a position 203 at 20 degrees, a position 205 at 30 degrees, a position 207 at 40 degrees, a position 209 at 45 degrees, a position 211 at 50 degrees, a position 213 at 60 degrees and a position 215 at 70 degrees. The seven slant angles correspond to rotation of a mobile device in clockwise direction from a horizontal position to a vertical position. Although not depicted in the figure, similar slant angles exist for rotation of the mobile device from a vertical position to a horizontal position in clockwise direction and anticlockwise direction, as well as for a rotation from a horizontal position to a vertical position m anticlockwise direction.

A slant keyboard program in the mobile device 101 receives angle of orientation data from an orientation instrument(s) in the mobile device 101. The orientation instrument(s) can be an accelerometer in some embodiments, while in other embodiments the orientation instruments include both an accelerometer and a gyroscope. The slant keyboard program maintains a range for each of the angles of display depicted in FIG. 2. Each of the ranges is defined by an upper margin and a lower margin. When the slant keyboard program detects a change in orientation of the mobile device 101 to the slant angle as depicted in FIG. 1, the slant keyboard program determines an angle of display range that encompasses the slant angle. In this illustration, the slant keyboard program determines that the angle of orientation data received from the orientation instrument(s) indicates a slant angle of 33 degrees. The slant keyboard program determines that the slant angle of 33 degrees falls within a slant angle range with an upper margin of 35 degrees and a lower margin of 25 degrees. This slant angle range corresponds to the position 205 in FIG. 2. The slant keyboard program selects the position 205 as the angle of display for the graphical keyboard 105, and displays the graphical keyboard at an angle of 30 degrees.

The slant keyboard program also selects a layout for the graphical keyboard 105 according to the angle of display of the graphical keyboard 105. Depending on available screen/display space, a graphical keyboard may have different layouts at different slant angles of display. To illustrate, at an angle of display of 45 degrees, a graphical keyboard may have a layout with four rows of keys. At an angle of display of 20 degrees, the graphical keyboard layout changes to five rows of keys with fewer keys in each row. The text area 109 is displayed horizontally on the touchscreen when the mobile device is in a horizontal position. The text area 109 is displayed vertically on the touchscreen when the mobile device 101 is at a vertical position. When the graphical keyboard 105 is displayed at a slant angle, the graphical keyboard partially overlays the text area 109. The graphical keyboard 105 includes the short-term text field 107 to display the last 30 characters typed by the user. The short-term text field 107 compensates for the partially hidden text of the text area 109, and aids with context of words preceding the cursor position. The short-term text field 107 displays a scrolling text stream corresponding to the last 30 characters typed by the user. The slant keyboard program also allows the user to display the graphical keyboard 105 by tapping anywhere in the text area 109. The slant keyboard program allows the user to hide the graphical keyboard 105 by tapping on the area outside the graphical keyboard 105.

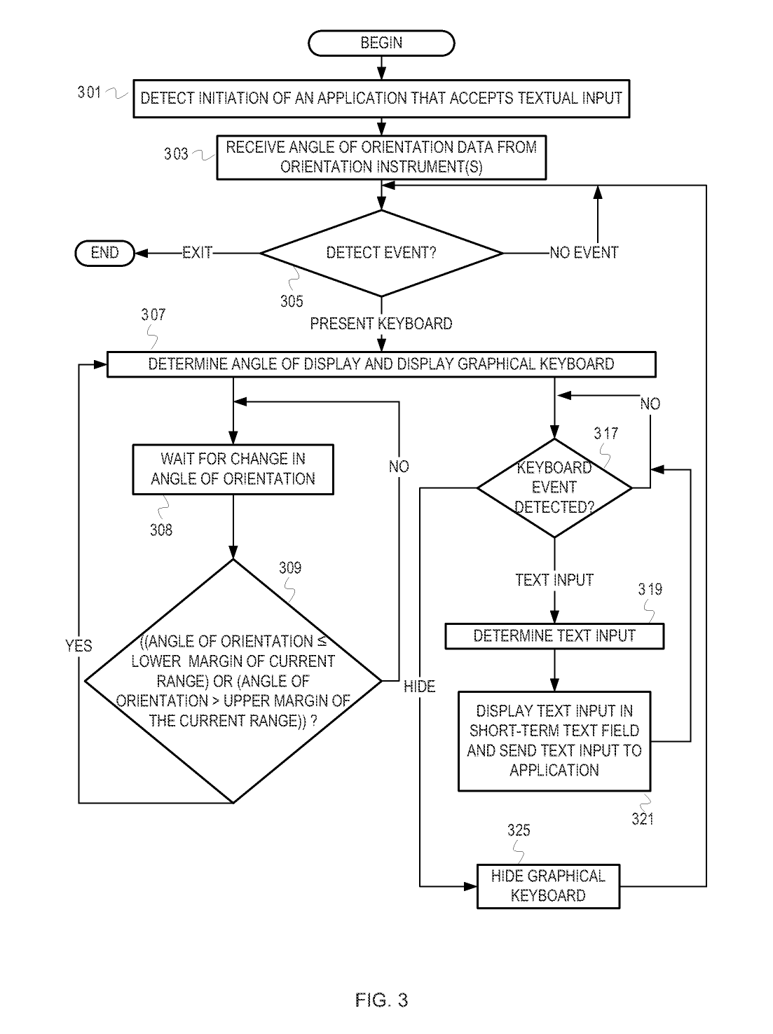

FIG. 3 illustrates a flow diagram of example operations to display a graphical keyboard and accept textual input,

At block 301, a slant keyboard program detects initiation of an application that accepts textual input. The slant keyboard program receives information about initiation of the application from an operating system.

At block 303, the slant keyboard program receives angle of orientation data from an orientation instrument(s) of a mobile device. The angle of orientation is an angle measure of the current position of the mobile device from a fixed reference position (lengthwise horizontal position) of the mobile device, For example, the angle of orientation in the horizontal position of the mobile device is 0 degrees. The slant keyboard program subscribes to a location in the operating system space where orientation instrument(s) firmware publishes values for the angle of orientation. The slant keyboard. program can receive the angle of orientation data through other techniques. For example, the slant keyboard program modifies the program instructions in orientation instrument(s) firmware to send angle of orientation data, to the slant keyboard program. The orientation instrument(s) firmware can also communicate with a slant keyboard program via, synchronous communication, using hand-shake signals. For example, the slant keyboard program can initiate a process with a start communication signal to the orientation instrument(s) firmware. On receiving the start communication signal, the orientation instrument(s) firmware sends the values of the angle of orientation to the slant keyboard program. The slant keyboard program sends an acknowledgement of receipt for an angle of orientation value, The orientation instrument(s) firmware resends the angle of orientation value if the acknowledgement is not received within a time-out period. The slant keyboard program ends the process by sending a stop communication signal.

At block 305, the slant keyboard program waits for an event. In this illustration, the slant keyboard program detects an event to exit or an event to present the graphical keyboard. For example, the slant keyboard program runs as a background process until an event to present the graphical keyboard is triggered by a tap in the text area of the application. If an event to present the graphical keyboard is detected, then control flows to block 307. if an event to exit is detected, then the slant keyboard program exits. Otherwise, control loops back to block 305.

At block 307, the slant keyboard program determines an angle of display and displays the graphical keyboard at the angle of display. The slant keyboard program identifies the slant angle range that encompasses the angle of orientation (bounded by a lower margin of the slant angle range and an upper margin of the slant angle range). The slant keyboard program selects the angle of display corresponding to the slant angle range and identifies a layout for the graphical keyboard corresponding to the angle of display. The slant keyboard program presents the keyboard at the angle of display in the layout. The control then flows to blocks 308 and 317 which execute parallel sets of operations: 1) operations to react to changes in orientation of the mobile device, and 2) operations to react to input corresponding to the graphical keyboard. Embodiments are not required to perform these sets of operations in parallel as if by concurrently executing threads. Embodiments can implement the functionality for handling input for the keyboard and functionality for reacting to changes in orientation in separate functions or programs. Indeed, the operations for processing input to display text or hide the graphical keyboard can be implemented by a program distinct from the slant keyboard program, and be invoked by the operating system in an event driven environment. Further, embodiments are not required to implement running processes that continuously monitor for events. The operations can be performed when another process invokes the function for hiding the keyboard or for updating the display angle of the graphical keyboard.

At block 308, the slant keyboard program waits for a change in the angle of orientation, The executing keyboard slant program can monitor a variable or memory location for a flag that indicates a change in angle of orientation. In some embodiments, a process of the slant keyboard program receives a message with a different angle of orientation. In response, the process determines whether the display angle is to be updated or invokes another function that determines whether the display angle is to be updated based on the new angle of orientation. Embodiments can institute a delay or reduce responsiveness of refreshing the keyboard angle of display to avoid too many changes in presentation of the display angle. For example, the slant keyboard program can be configured to determine whether the angle of orientation has changed at given time intervals. In addition, the slant keyboard program can be configured to lock the graphical keyboard at a particular slant angle of display.

At block 309, the slant keyboard program determines if the angle of orientation is less than or equal to a lower margin of a current slant angle range. The slant keyboard program also determines if the angle of orientation is greater than an upper margin of the current slant angle range. If either of the conditions is true, then control flows to block 307. If none of the conditions is true, control loops back to block 308. Embodiments do not necessarily define the slant angle ranges to include the lower margin. Embodiments can define the slant angle ranges to include the upper margin and not the lower margin.

At block 317, the slant keyboard program determines whether a keyboard event occurs. For example, an event to enter text is triggered by a tap from the user on the graphical keyboard. In this example illustration, keyboard events can be a text input event and a hide keyboard event. Embodiments can implement additional keyboard events, such as an exit application event. If an event to enter text in the application is detected, control flows to block 319. If an event to hide the keyboard is detected, then control flows to block 325. If no keyboard event is detected, then control loops back to block 317.

At block 319, the slant keyboard program determines the text input for the application. For example, the slant keyboard program maps the co-ordinates of the graphical keyboard tapped on by the user to a character.

At block 321, the slant keyboard program displays the text input in a short-term text field. The slant keyboard program also sends the text input to the application. The short-term text field is not limited to displaying 30 characters, and can display fewer or more characters preceding the cursor. The short-term text field can also display characters succeeding the cursor, if the cursor has text succeeding the cursor. From block 321, control flows back to block 317.

If the keyboard event was a hide keyboard event, then control flowed to block 325. An event to hide the graphical keyboard may be triggered by a tap from the user outside the graphical keyboard. An event to hide the graphical keyboard can also correspond to exit from the application. At block 325, the slant keyboard program hides the graphical keyboard. Unless the keyboard hide event was a result of the application exiting, control flows from block 325 back to block 305.

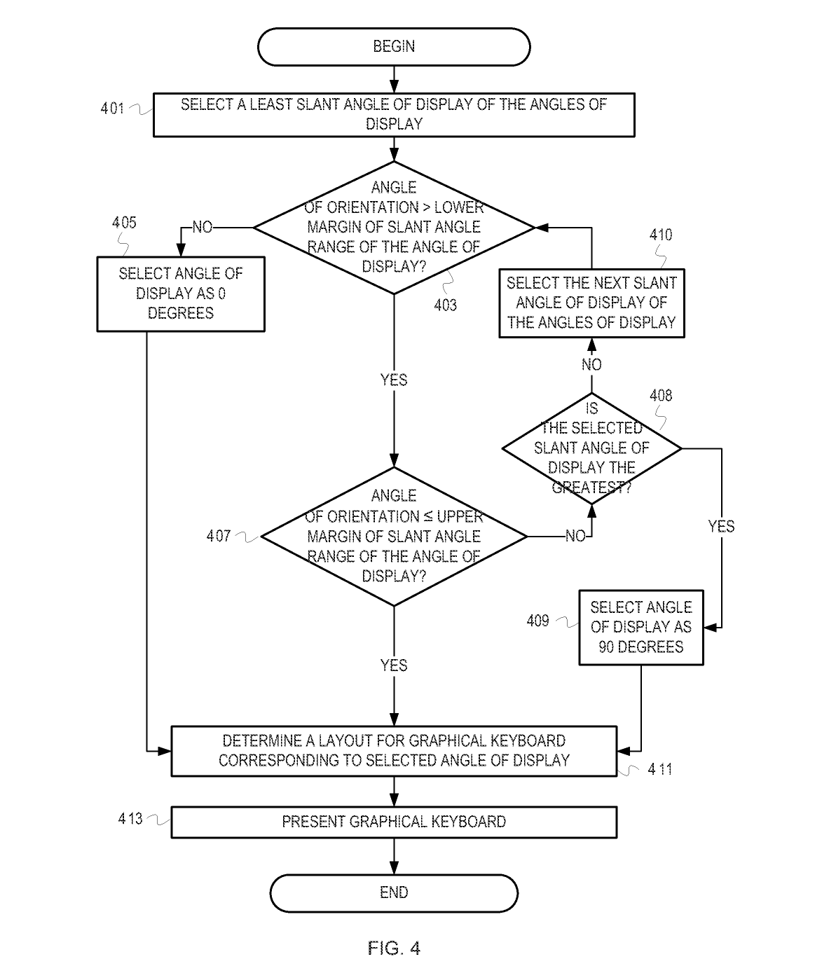

FIG. 4 illustrates a flow diagram of example operations to determine an angle of display for a graphical keyboard and display the graphical keyboard. The example operations depicted in FIG. 4 correspond to the example operation of block 307 in FIG. 3.

At block 401, the slant keyboard program selects a least slant angle of display of the angles of display. Embodiments are not limited to starting with the least angle of display, and can start from the greatest angle of display, the median angle of display, the last used angle of display, etc.

At block 403, the slant keyboard program checks if the angle of orientation is greater than a lower margin of a slant angle range of the selected angle of display. If the angle of orientation is greater than the lower margin, then control flows to block 407. If the angle of orientation is not greater than the lower margin, then control flows to block 405.

At block 405, the slant keyboard program selects 0 degrees as the angle of display for the graphical keyboard, which corresponds to the horizontal position for the graphical keyboard. The control then flows to block 411.

At block 407, the slant keyboard program checks if the angle of orientation is less than or equal to an upper margin of the slant angle range of the selected angle of display. If the angle of orientation is less than or equal to the upper margin, then control flows to block 411. If the angle of orientation is not less than or equal to the upper bound margin range angle, control flows to block 408,

At block 408, the slant keyboard program determines if the selected slant angle of display is the greatest. If the selected slant angle range is the greatest, then control flows to block 409. If the selected slant angle range is not the greatest, then control flows to block 410.

At block 409, the slant keyboard program selects the angle of display as 90 degrees. Control flows from block 409 to block 411.

At block 410, the slant keyboard program selects the next slant angle of display. Control flows from block 410 back to block 403.

At block 411, the slant keyboard program determines a layout for the graphical keyboard. The slant keyboard program determines a layout in accordance with the selected angle of display. The slant keyboard program selects a layout from a pre-determined set of layouts for the graphical keyboard. A variety of data structures can be employed to associate the different layouts with the different slant angles of display. For the horizontal and vertical positions, the slant keyboard program can leverage keyboard layouts already defined in the operating system and/or application.

At block 413, the slant keyboard program presents the graphical keyboard. The slant keyboard program displays the graphical keyboard on the touchscreen of the mobile device.

Those of ordinary skill in the art should understand that the depicted flowcharts are examples to aid in understanding the inventive subject matter, and should not be used to limit the scope of the claims. Embodiments can perform additional operations not depicted, fewer than the depicted operations, the operations in a different order, the operations in parallel, etc. The scope of the inventive subject matter is not limited to rotation of a mobile device in clockwise or anti-clockwise direction. In either direction of rotation of the mobile device, the slant keyboard program displays the graphical keyboard at an angle in a direction opposite to the angle of rotation. Also, the scope of the inventive subject matter is not limited to rotation of the mobile device from 0 degrees to 90 degrees. Similar slant angles of display exist for the angles of orientation of the mobile device in other quadrants. Furthermore, embodiments are not limited to selecting a layout from a predefined set of layouts. Embodiments can dynamically determine a layout for a slant angle of display. For example, the slant keyboard program computes a number of rows and keys in each row for a layout based on dimensions of a screen and the slant angle of display. Another factor may be a threshold(s) that limits the amount of application space that the slant graphical keyboard can occupy. In some embodiments, the slant keyboard program can dynamically adjust sizes of the keys and/or hide keys based on various factors including type of application, type of character associated with the key, use history, etc. For example, vowels and commonly used consonants may be larger than less frequently used characters (e.g., ‘z’) for an instant messaging application while all keys are shown for a word processing application. In some embodiments, a wildcard key maps to multiple least used characters. In some embodiments the graphical keyboard also exhibits transparency in part or full, thus allowing at least some of the text underneath the graphical keyboard to be visible.

The graphical keyboard can be displayed in color with different colors for key characters and key boundaries. Embodiments can present the graphical keyboard in colors that sharply contrast with the text area. In some embodiments, the slant keyboard program allows the user to rotate the graphical keyboard by placing two fingers on sides of the graphical keyboard and rotating the fingers, without changing orientation of the mobile device.

In some embodiments, the slant keyboard program allows the user to set custom slant angles of display and/or margins for the slant angle ranges. Also, the positions of display for the graphical keyboard are not limited to seven slant angle ranges and can be further extended. The slant keyboard program can be implemented over a wide range of mobile devices including smartphones, tablets, personal digital assistants, etc.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java®, Smalltalk, C++ or the like and conventional procedural programming languages, such as the “C” programming language or similar programming languages. The program code may execute entirely on the user's mobile device, partly on the user's mobile device, as a stand-alone software package, partly on the user's mobile device and partly on a remote computer or entirely on a remote computer or server, In the latter scenario, the remote computer may be connected to the user's mobile device through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose mobile device, special purpose mobile device, or other programmable data processing apparatus to produce a machine, such that the instructions, which execute via the processor of the mobile device or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a mobile device, other programmable data processing apparatus, or other devices to cause a series of operational steps to be performed on the mobile device, other programmable apparatus or other devices to produce a mobile device implemented process such that the instructions which execute on the mobile device or other programmable apparatus provide processes for implementing the functions/acts specified in the flowchart and/or block diagram block or blocks.

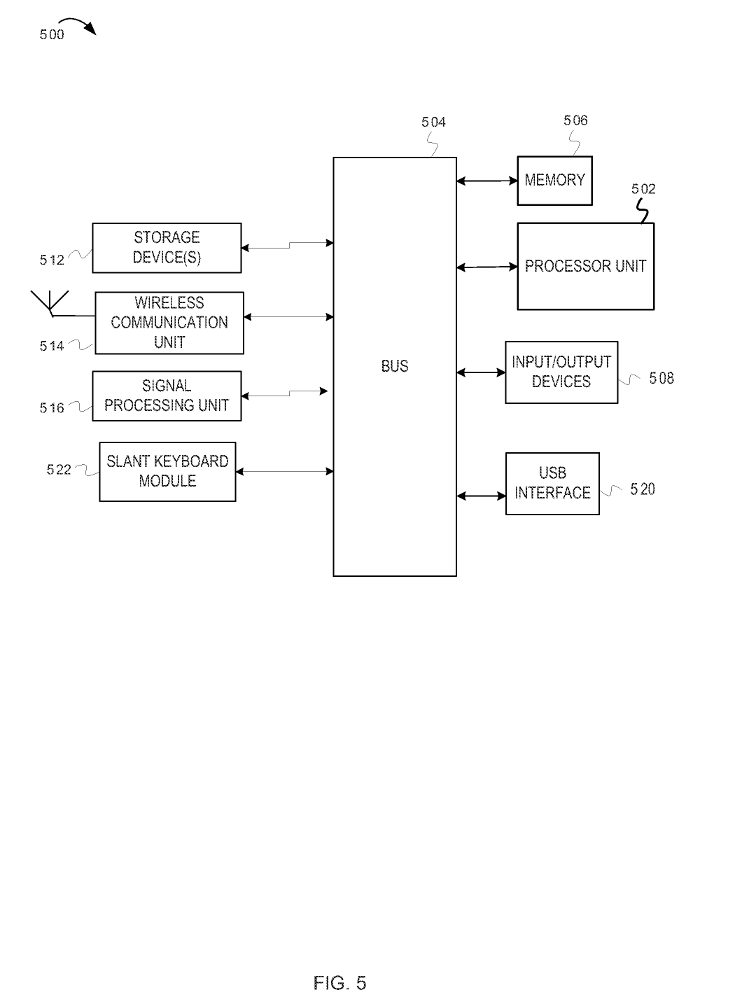

FIG. 5 depicts an example mobile device 500. A mobile device includes a processor unit 502 (possibly including multiple processors, multiple cores, multiple nodes, and/or implementing multi-threading, etc.), a memory 506, input/output devices 508, a signal processing unit 516, a slant keyboard module 522 and a USB interface 520. The slant keyboard module 522 receives angle of orientation data and displays a graphical keyboard at a slant angle of display in the mobile device 500 as described above. The slant keyboard module 522 may be a hardware chip (e.g., PLA, PAL, FPGA, etc.) programmed with program instructions to perform the functionality as described above. The slant keyboard module 522 may be implemented with an application specific integrated circuit, in logic implemented in the processor unit 502, in a co-processor on a peripheral device or card, etc. In addition, at least some of the functionality of the slant keyboard module 522 may be embodied as program instructions in the memory 506 or the storage device(s) 512. The memory 506 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The input/output devices 508 may include a touchscreen, accelerometer, gyro sensors, camera, microphone LCD display, LED, audio jack, speaker, etc. The signal processing unit 516 may include audio DSP's, video DSP's, etc. The USB interface 520 may consist of a Mini-USB, a Micro-USB, etc. The mobile device 500 also includes a bus 504 (e.g., PCI, ISA, PCI-Express, HyperTransport®, InfiniBand®, NuBus, etc.), a wireless communication unit 514 (e.g., a GSM interface, a CDMA interface, a Bluetooth interface, an infrared interface, a FM interface, a GPS interface, a WLAN interface etc.) and a storage device(s) 512 (e.g., SD card, SIM card, etc.). Further, realizations may include fewer or additional components not illustrated in FIG. 5 (e.g., video cards, audio cards, additional network interfaces, peripheral devices, etc.). The processor unit 502, the input/output devices 508, the storage device(s) 512, the wireless communication unit 514, the signal processing unit 516 and the USB interface 520 are coupled to the bus 504. Although illustrated as being coupled to the bus 504, the memory 506 may be coupled to the processor unit 502.

While the embodiments are described with reference to various implementations and exploitations, it will be understood that these embodiments are illustrative and that the scope of the inventive subject matter is not limited to them. In general, techniques to present keyboard and accept input as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components, These and other variations, modifications, additions, and improvements may fall within the scope of the inventive subject matter.

What is claimed is:

1. A method comprising:
detecting initiation of an application that accepts textual input in a mobile device;
receiving angle of orientation data from one or more orientation instruments in the mobile device;
determining that the angle of orientation data indicates a slant angle of orientation; and
displaying a graphical keyboard on a screen of the mobile device at a slant angle of display corresponding to the slant angle of orientation and displaying the graphical keyboard with a short-term text field also at the slant angle of display, wherein the short-term text field displays a limited number of most recent input characters to the graphical keyboard.

2. The method of claim 1 further comprising:
subscribing to a location in an operating system space of the mobile device, wherein the one or more orientation instruments publish the angle of orientation data to the location,
wherein said receiving the angle of orientation data from the one or more orientation instruments in the mobile device comprises detecting the angle of orientation data at the location.

3. The method of claim 1, wherein said receiving the angle of orientation data from the orientation instruments in the mobile device comprises:
receiving the angle of orientation data from the one or more orientation instruments through synchronous communications with a process associated with the one or more orientation instruments.

4. The method of claim 1 further comprising:
determining that the slant angle of orientation is within a first of a plurality of ranges of slant angles of display,
wherein the first of the plurality of ranges of slant angles of display is associated with the slant angle of display.

5. The method of claim 4, wherein said determining that the slant angle of orientation is within the first of the plurality of ranges of slant angles of display comprises:
comparing the slant angle of orientation against a lower margin of the first of the plurality of ranges of slant angles of display and an upper margin of the first of the plurality of ranges of slant angles of display.

6. The method of claim 4 further comprising:
evaluating the slant angle of orientation against different ones of the plurality of ranges of slant angles of display until determining that the slant angle of orientation is within the first of the plurality of ranges of slant angles of display.

7. The method of claim I, wherein said displaying the graphical keyboard at the slant angle of display comprises at least partially obstructing a text area of the application to accommodate the graphical keyboard at the slant angle of display and displaying the graphical keyboard translucently.

8. The method of claim 1 further comprising determining a first graphical keyboard layout of a plurality of graphical keyboard layouts based, at least in part, on the slant angle of display, wherein said displaying the graphical keyboard at the slant angle of display comprises displaying the graphical keyboard in accordance with the first graphical keyboard layout.

9. A computer program product for displaying a graphical keyboard at a slant angle of display, the computer program product comprising:
a computer readable storage medium having computer usable program code embodied therewith, the computer usable program code comprising a computer usable program code configured to:
detect initiation of an application that accepts textual input in a mobile device;
receive angle of orientation data from one or more orientation instruments in the mobile device;
determine that the angle of orientation data indicates a slant angle of orientation; and
display a graphical keyboard on a screen of the mobile device at a slant angle of display corresponding to the slant angle of orientation and display the graphical keyboard with a short-term text field also at the slant angle of display, wherein the short-term text field displays a limited number of most recent input characters to the graphical keyboard.

10. The computer readable storage medium of claim 9, wherein the computer usable program code is further configured to:
subscribe to a location in an operating system space of the mobile device, wherein the one or more orientation instruments publish the angle of orientation data to the location,
wherein the computer usable program code configured to receive the angle of orientation data from the one or more orientation instruments in the mobile device comprises the computer usable program code configured to detect the angle of orientation data at the location.

11. The computer readable storage medium of claim 9, wherein the computer usable program code configured to receive the angle of orientation data from the orientation instruments in the mobile device comprises the computer usable program code configured to:
receive the angle of orientation data from the one or more orientation instruments through synchronous communications with a process associated with the one or more orientation instruments.

12. The computer readable storage medium of claim 9, wherein the computer usable program code is further configured to:
determine that the slant angle of orientation is within a first of a plurality ranges of slant angles of display,
wherein the first of the plurality of ranges of slant angles of display is associated with the slant angle of display.

13. The computer readable storage medium of claim 12, wherein the computer usable program code configured to determine that the slant angle of orientation is within the first of the plurality of ranges of slant angles of display comprises the computer usable program code configured to:
compare the slant angle of orientation against a lower margin of the first of the plurality of ranges of slant angles of display and an upper margin of the first of the plurality of ranges of slant angles of display.

14. The computer readable storage medium of claim 12, wherein he computer usable program code is further configured to:
evaluate the slant angle of orientation against different ones of the plurality of ranges of slant angles of display until determining that the slant angle of orientation is within the first of the plurality of ranges of slant angles of display.

15. An apparatus comprising:
a processor;
a touchscreen coupled with the processor; and
a slant keyboard module having computer usable program code embodied therewith, the computer usable program code comprising a computer usable program code configured to:
detect initiation of an application that accepts textual input in a mobile device;
receive angle of orientation data from one or more orientation instruments in the mobile device;
determine that the angle of orientation data indicates a slant angle of orientation; and
display a graphical keyboard on the touchscreen of the mobile device at a slant angle of display corresponding to the slant angle of orientation and display the graphical keyboard with a short-term text field also at the slant angle of display, wherein the short-term text field displays a limited number of most recent input characters to the graphical keyboard.

16. The apparatus of claim 15, wherein the computer usable program code is further configured to:
subscribe to a location in an operating system space of the mobile device, wherein the one or more orientation instruments publish the angle of orientation data to the location,
wherein the computer usable program code configured to receive the angle of orientation data from the one or more orientation instruments in the mobile device comprises the computer usable program code configured to detect the angle of orientation data at the location.

17. The apparatus of claim 15, wherein the computer usable program code configured to receive the angle of orientation data from the orientation instruments in the mobile device comprises the computer usable program code configured to:
receive the angle of orientation data from the one or more orientation instruments through synchronous communications with a process associated with the one or more orientation instruments.

18. The apparatus of claim 15, wherein the computer usable program code is further configured to:
determine that the slant angle of orientation is within a first of a plurality of ranges of slant angles of display,
wherein the first of the plurality of ranges of slant angles of display is associated with the slant angle of display.

19. The apparatus of claim 18, wherein the computer usable program code configured to determine that the slant angle of orientation is within the first of the plurality of ranges of slant angles of display comprises the computer usable program code configured to:
compare the slant angle of orientation against a lower margin of the first of the plurality of ranges of slant angles of display and an upper margin of the first of the plurality of ranges of slant angles of display.

20. The apparatus of claim 18, wherein the computer usable program code is further configured to:
evaluate the slant angle of orientation against different ones of the plurality of ranges of slant angles of display until determining that the slant angle of orientation is within the first of the plurality of ranges of slant angles of display.
